(19) United States
(12) Patent Application Publication
(10) Pub. No.: US 2004/0163930 A1
(43) Pub. Date: Aug. 26, 2004

(54) Crossover conveyor apparatus

(75) Inventor: Lionel John Work, Fort St. James (CA)

Correspondence Address: KOLISCH HARTWELL, P.C., 520 S.W. YAMHILL STREET, SUITE 200, PORTLAND, OR, 97204, US

(73) Assignee: Western Pneumatics, Inc.

(21) Appl. No.: 10/309,749

(22) Filed: Dec. 3, 2002

(51) Int. Cl. B27F 1/00

(52) U.S. Cl. 198/456

(57) ABSTRACT

A crossover device for a finger jointer includes a chain having teeth to grip the end of a workpiece and move it perpendicular to a main conveyor direction. A main conveyor and a crossover conveyor may be driven by the same drive mechanism.

### FIELD OF THE INVENTION

The invention relates to material conveyance. In particular, the invention provides an improved crossover mechanism for moving pieces of wood laterally between finger cutting steps prior to a finger jointing operation.

### BACKGROUND OF THE INVENTION

Manufacturing procedures sometimes require movement of a piece of material forward and laterally side-to-side simultaneously. For example, finger jointing is a method of connecting small pieces of wood end-to-end to produce a longer piece of lumber. Typically, fingers are cut on opposite ends of a single board. The board moves in a conveyor direction perpendicular to the long axis of the board. A finger cut is made on one end of the board. The board then translates forward while being pushed laterally side-to-side so that the uncut opposite end of the board can be eventually positioned for finger joint cutting downstream.

Prior finger jointing operations have used a “crossover” consisting of a belt oriented diagonally to the main conveyor direction. The objective is for the belt to frictionally grip the uncut end of the board and push it side-to-side in a direction perpendicular to the conveyor direction until the uncut end of the board is positioned for finger cutting. However, there are a number of problems with conventional crossover devices which result in equipment failure and processing downtime. For example, boards tend to slip relative to the crossover belt causing the board to shift in a skewed orientation relative to the conveyor direction. This slippage may result in jam-ups, damage to the main conveyor chain, damage to the blocks of woods, loss of production, and safety hazards.

Another problem with conventional crossover belts is that they wear out quickly, particularly when used at high conveyor speeds. Belts may work satisfactorily when new, but rapidly deteriorate causing lost production, downtime, and high cost for labor and parts.

Another problem with conventional crossover devices is that it is difficult to match the speed of the crossover with the speed of the main conveyor, particularly as the speed of the main conveyor is varied. This may cause blocks of material to be transferred across the chain out of square causing uneven wear on the lugs on the main conveyor chain, and jam-ups. Blocks of wood may overshoot the lumber line target causing short fingers to be cut, resulting in failure of the finished product, and lost production time.

Accordingly, there is a need for an improved crossover mechanism that addresses some or all of the problems discussed above.

### SUMMARY OF THE INVENTION

The invention provides an improved crossover device. Numerous aspects of the crossover device may be employed separately or cooperatively to translate a board accurately in a forward direction and side-to-side simultaneously in preparation for a finger jointing operation. The crossover may utilize a chain having teeth for positively gripping an end of a board and moving it side-to-side. The crossover may also utilize a direct drive linkage between the main lug conveyor and the crossover so that changes in speed of the main lug chain automatically translate precisely into an appropriate speed change of the crossover chain.

### BRIEF DESCRIPTION OF THE DRAWINGS

FIG. 1 is a plan view of a finger cutting and conveyor system.

FIG. 2 is a partially cut-away top view of a crossover and conveyor system.

FIG. 3 is a top view of a crossover chain having teeth for gripping the end of a board.

FIG. 4 is a side view of the chain shown in FIG. 3.

FIG. 5 is a partial top view of a crossover device showing a portion of the drive mechanism.

FIG. 6 is a side view of a drive linkage for a crossover device.

### DETAILED DESCRIPTION AND BEST MODE FOR CARRYING OUT THE INVENTION

The invention provides an improved crossover mechanism which is capable of gripping an end of a board and moving it transversely to a main conveyor direction past and through milling devices that cut finger configurations on opposite ends of a workpiece such as a board or block.

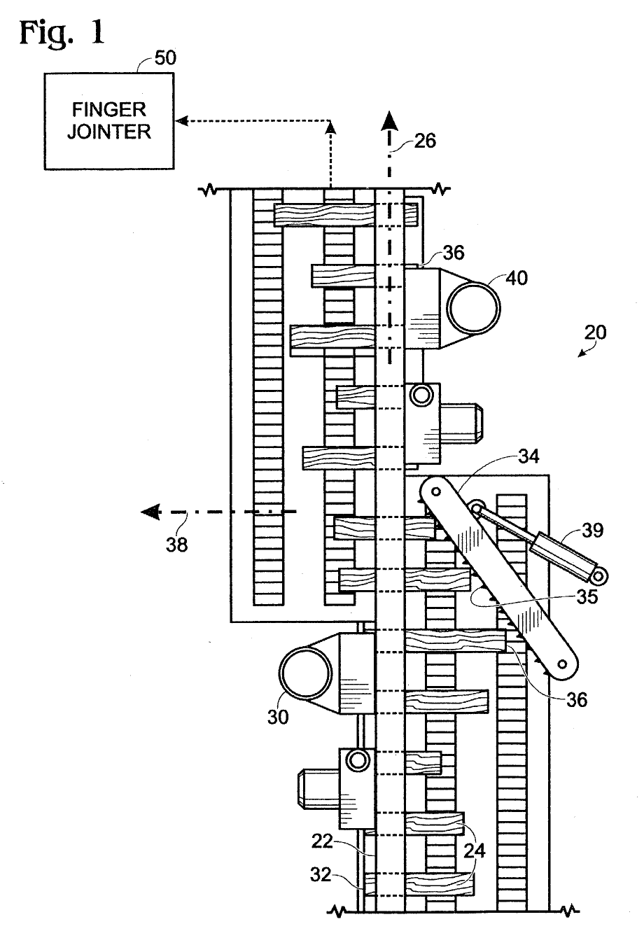

FIG. 1 shows a conveyor system 20. A main conveyor, for example, lug chain 22 carries workpieces 24 in the direction of arrow 26. Milling device 30 is positioned downstream for cutting a finger configuration on a first end portion 32 of workpiece 24.

Further downstream crossover 34 is positioned diagonally relative to main conveyor direction 26. Chain device 35 of crossover 34 contacts end portion 36 of workpiece 24 causing workpiece 24 to move in the direction of arrow 38 perpendicular to main conveyor direction 26. Pneumatic cylinder 39 is provided to pull crossover 34 out of the way when it is not being used or if there is a jam up downstream.

Second milling device 40 is positioned further downstream for cutting a finger configuration in end portion 36 of workpiece 24. Workpiece 24 is then conveyed to finger jointer 50 where multiple workpieces are glued end-to-end.

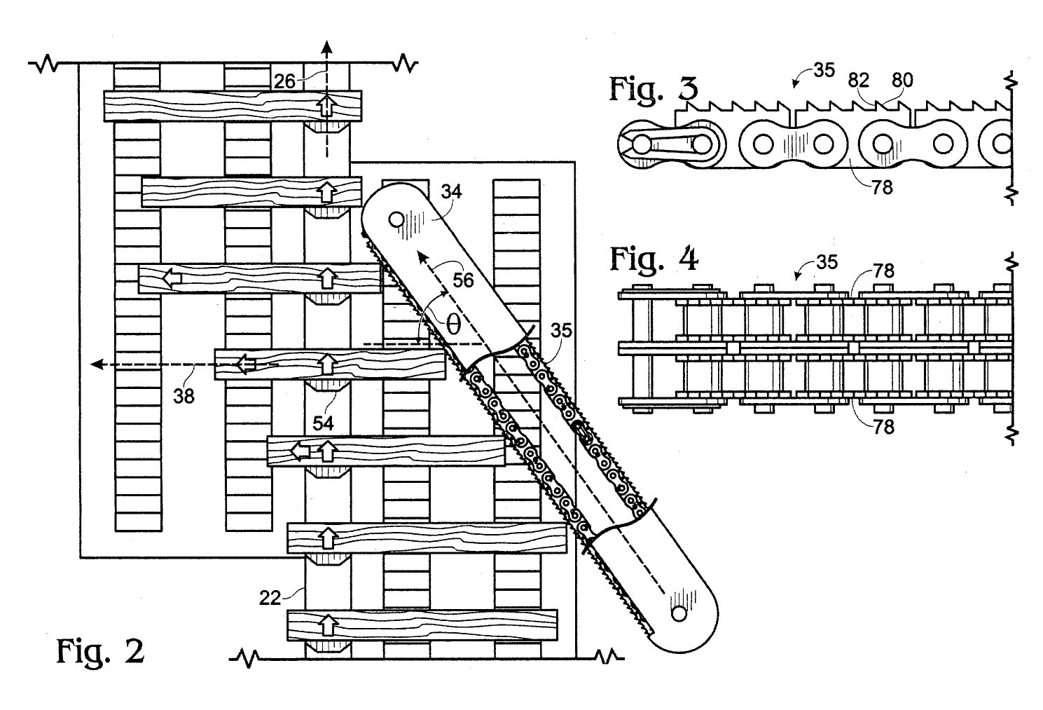

FIG. 2 shows crossover 34 oriented relative to main conveyor and lug chain 22. Lug chain 22 has lugs 54 for carrying workpieces in the direction of arrow 26. Crossover 34 is oriented diagonally utilizing chain 35 which runs in the direction of arrow 56 to push workpieces side-to-side in the direction of arrow 38 perpendicular to main conveyor direction 26 between milling devices. The angle θ formed between main conveyor 22 and crossover 34 is preferably between about 30°-40°. Angle θ in FIG. 2 is 36°. In processing direction 26, main conveyor 22 moves 40 feet while crossover chain 35 moves 50 feet. It is important that the relative speeds of lug chain 22 and crossover chain 35 be appropriately matched. In the configuration shown in FIG. 2, the lug conveyor 22 moves at 80% of the velocity of crossover chain 35 at all times, and the speed alterations changes of the chains are synchronized.

An adjustment device may also be incorporated for altering angle θ, plus or minus 3° on either side of 36°. This allows for fine tuning the crossover speed relative to the lug chain speed.

To eliminate slippage of workpieces being conveyed transversely by crossover 34, a double fifty-pitch sharp chain is used, for example, as shown in FIGS. 3 and 4. Chain 35 is provided with teeth links 78. Each of teeth links 78 has five teeth 80 which are milled to a sharp configuration by grinding out portions 82 of teeth 80. FIG. 4 shows a side view of chain 35, i.e., the side of the chain that contacts and grips end portions of boards or workpieces 24. Chain 35 is doubled including four rows of tooth links 78.

Chain 35 is effective for biting and gripping end portions of workpieces as they translate downstream. It may also be useful to provide a “stripper blade” at the downstream end of the crossover frame to prevent workpieces from going around the head and sprocket passing away from the trim saw shear guide.

It is possible to use separate drive mechanisms for lug chain 22 and crossover chain 35. However, it is then necessary to employ a precise speed control device so that the chains change velocity together, thus maintaining the desired speed ratio.

Alternatively, the preferred approach is to use one drive mechanism, with an appropriate gear ratio, to drive lug chain 22 and crossover chain 35 simultaneously, always maintaining the desired ratio of chain velocities.

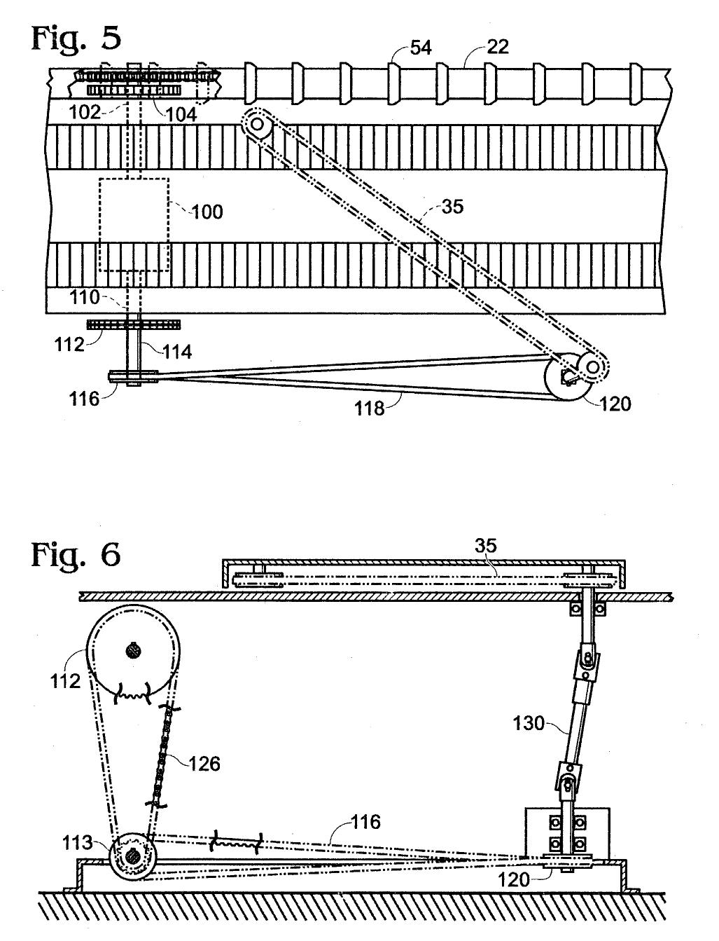

FIG. 5 shows a drive mechanism for a crossover device. In FIG. 5, the same motor 100 is used to drive lug chain 22 and crossover chain 35. Motor 100 drives rotation of shaft 102 and sprocket 104 which carries the chain for lug conveyor 22. Motor 100 also drives rotation of shaft 110 and sprocket 112 which is preferably a 44 tooth sprocket. Sprocket 112 carries chain 126, as shown in FIG. 6. Chain 126 is a 60 pitch chain. Chain 126 then drives a 14 tooth sprocket 113. The relative sizes of sprocket 112 and 113 determine the appropriate speed ratio between the lug conveyor and the crossover chain. Shaft 114 is connected to pulley 116 which is configured to engage a lug belt 118. Belt 118 twists 90 degrees before engaging pulley 120. Pulley 120 is then connected to crossover chain 35 via shaft 130 and appropriate universal joints to allow some degree of movement or offset while maintaining the desired revolution speed.

Each of the following U.S. patents is incorporated by reference in its entirety: U.S. Pat. Nos. 6,382,067; 6,189,682; 6,082,421; 5,617,910; 4,294,647; 4,164,248; 3,927,705; and 3,033,341.

While the invention has been disclosed in its preferred form, the specific embodiments thereof as disclosed and illustrated herein are not to be considered in a limiting sense as numerous variations are possible. Applicant regards the subject matter of the invention to include all novel and non-obvious combinations and subcombinations of the various elements, features, functions and/or properties disclosed herein. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of applicant's invention.

I claim:

1. A conveyor system for processing opposite ends of a work piece comprising
a main conveyor for carrying a series of work pieces in a first direction,
a crossover conveyor oriented diagonally relative to the main conveyor, the crossover conveyor being configured to push work pieces in a direction perpendicular to the first direction, wherein the crossover conveyor includes teeth structures for gripping an end of a work piece.

2. The conveyor system of claim 1, wherein the crossover conveyor has at least one chain including a plurality of links, each link having one or more teeth structures for gripping an end of a work piece.

3. The conveyor system of claim 1 further comprising
a drive mechanism that drives the main conveyor and the crossover conveyor so the relative speeds of the two conveyors are continuously coordinated.

4. The conveyor system of claim 3, wherein the drive mechanism includes a motor.

5. The conveyor system of claim 1, wherein the crossover conveyor forms an angle relative to the first direction in the range of approximately about 25 degrees to 45 degrees.

6. The conveyor system of claim 1, wherein the crossover conveyor forms an angle relative to the first direction of approximately 36 degrees.

7. The conveyor system of claim 1 further comprising
a drive linkage connecting the main conveyor and the crossover conveyor, the drive linkage including a first sprocket member connected to the main conveyor, a second sprocket member connected to the crossover conveyor, a first chain connecting the first sprocket member to the second sprocket member, wherein the relative sizes of the first and second sprockets are selected so that the speeds of the main conveyor and the crossover conveyor are coordinated.

8. The conveyor system of claim 1 further comprising
an adjustment mechanism allowing adjustment of the angle formed between the crossover conveyor and the main conveyor.

9. A conveyor system for processing opposite ends of a work piece comprising
a main conveyor for carrying a series of work pieces in a first direction,
a crossover conveyor oriented diagonally relative to the main conveyor, the crossover conveyor being configured to push work pieces in a direction perpendicular to the first direction, and
a drive mechanism including a motor, main conveyor and the crossover conveyor being driven by the same motor, so the relative speeds of the two conveyors are continuously coordinated.

10. The conveyor of claim 9, wherein the crossover conveyor includes a chain having teeth for gripping an end of a workpiece.

11. The conveyor system of claim 9 further comprising
a drive linkage connecting the main conveyor and the crossover conveyor, the drive linkage including a first sprocket member connected to the main conveyor, a second sprocket member connected to the crossover conveyor, a first chain connecting the first sprocket member to the second sprocket member, wherein the relative sizes of the first and second sprockets are selected so that the speeds of the main conveyor and the crossover conveyor are coordinated.

12. The conveyor system of claim 9 further comprising
first and second finger cutting devices positioned in series adjacent the main conveyor for cutting finger configurations on opposite ends of a work piece.

13. A conveyor system for processing opposite ends of a work piece comprising
a main conveyor for carrying a series of work pieces in a first direction,
a crossover conveyor oriented diagonally relative to the main conveyor, the crossover conveyor being configured to push work pieces in a direction perpendicular to the first direction, and
a speed control mechanism that automatically maintains a desired speed ratio of the main conveyor and the crossover conveyor as the speeds of both conveyors vary.

14. The conveyor system of claim 13, wherein the speed control mechanism includes a motor, both conveyors being driven by the same motor.

15. The conveyor system of claim 13 further comprising
a drive linkage connecting the main conveyor and the crossover conveyor, the drive linkage including a first sprocket member connected to the main conveyor, a second sprocket member connected to the crossover conveyor, a first chain connecting the first sprocket member to the second sprocket member, wherein the relative sizes of the first and second sprockets are selected so that the speeds of the main conveyor and the crossover conveyor are coordinated.
